(19) United States
(12) Patent Application Publication
(10) Pub. No.: US 2020/0386053 A1
(43) Pub. Date: Dec. 10, 2020

(54) WHIPSTOCK ASSEMBLY

(71) Applicant: Weatherford Technology Holdings, LLC, Houston, TX (US)

(72) Inventor: David W. TEALE, Spring, TX (US)

(21) Appl. No.: 16/431,457

(22) Filed: Jun. 4, 2019

(51) Int. Cl. E21B 7/06; E21B 29/06; B21D 28/26; B23K 26/38; B24C 1/04

(52) U.S. Cl. CPC E21B 7/061; E21B 29/06; B29C 45/14336; B23K 26/38; B24C 1/045; B21D 28/26

(57) ABSTRACT

A method of manufacturing a whipstock assembly includes cutting a shape of a body plate from a flat metal plate; forming a concave surface in the body plate; and attaching a body core to the body plate in a mold.

### BACKGROUND

### Field

Embodiments of the present disclosure relate to a whipstock. In particular, this disclosure relates to a composite whipstock assembly for creating a window within a wellbore.

### Description of the Related Art

In recent years, technology has been developed which allows an operator to drill a primary vertical well, and then continue drilling an angled lateral borehole off of that vertical well at a chosen depth. Generally, the vertical, or “parent” wellbore is first drilled and then supported with strings of casing. The strings of casing are cemented into the formation by the extrusion of cement into the annular regions between the strings of casing and the surrounding formation. The combination of cement and casing strengthens the wellbore and facilitates the isolation of certain areas of the formation behind the casing for the production of hydrocarbons.

In many instances, the parent wellbore is completed at a first depth, and is produced for a given period of time. Production may be obtained from various zones by perforating the casing string. At a later time, it may be desirable to drill a new “sidetrack” wellbore utilizing the casing of the parent wellbore. In this instance, a tool known as a whipstock is positioned in the casing at the depth where deflection is desired, typically at or above one or more producing zones. The whipstock is used to divert milling bits into a side of the casing in order create an elongated elliptical window in the parent casing. Thereafter, a drill bit is run into the parent wellbore. The drill bit is deflected against the whipstock, and urged through the newly formed window. From there, the drill bit contacts the rock formation in order to form a new lateral hole in a desired direction. This process is sometimes referred to as sidetrack drilling.

When forming the window through the casing, an anchor is first set in the parent wellbore at a desired depth. The anchor is typically a packer having slips and seals. The anchor tool acts as a fixed body against which tools above it may be urged to activate different tool functions. The anchor tool typically has a key or other orientation-indicating member.

A whipstock is next run into the wellbore. The whipstock has a body that lands into or onto the anchor. A stinger is located at the bottom of the whipstock which engages the anchor device. At a top end of the body, the whipstock includes a deflection portion having a concave face. The stinger at the bottom of the whipstock body allows the concave face of the whipstock to be properly oriented so as to direct the milling operation. The deflection portion receives the milling bits as they are urged downhole. In this way, the respective milling bits are directed against the surrounding tubular casing for cutting the window.

In order to form the window, a milling bit, or “mill,” is placed at the end of a string of drill pipe or other working string. In some milling operations, a series of mills are run into the hole. First, a starting mill is run into the hole. Rotation of the string with the starting mill rotates the mill, causing a portion of the casing to be removed. This mill is followed by other mills, which complete the creation of the elongated window.

Embodiments of the present disclosure provide a composite whipstock assembly for use in a sidetrack drilling operation.

### SUMMARY

In one embodiment, a method of manufacturing a whipstock assembly includes cutting a shape of a body plate from a flat metal plate; forming a concave surface in the body plate; and attaching a body core to the body plate in a mold.

In another embodiment, a method of manufacturing a whipstock assembly includes cutting a shape of a body plate from a flat metal plate; forming a concave surface in the body plate; forming a body core in a mold; removing the body core from the mold; and attaching the body plate to the body core.

In another embodiment, a whipstock assembly includes a body plate having a concave surface and a plurality of tabs; and a body core attached to the body plate, wherein the body core is formed in a mold with the body plate.

### BRIEF DESCRIPTION OF THE DRAWINGS

So that the manner in which the above recited features of the present disclosure are attained and can be understood in detail, a more particular description of the disclosure, briefly summarized above, may be had by reference to the drawings that follow. The drawings illustrate only selected embodiments of this disclosure, and are not to be considered limiting of its scope.

FIG. 1 is a perspective view of one embodiment of a whipstock assembly for milling a window in a wellbore.

FIG. 2 is a schematic top view of one embodiment of the whipstock assembly for milling a window in a wellbore.

FIG. 2A is a schematic view of one embodiment of a body plate of the whipstock assembly of FIG. 2. FIG. 2A shows the body plate as a flat plate

FIG. 2B is a partial, side view of the body plate of the whipstock assembly of FIG. 2.

FIG. 2C shows a partial, cross-sectional view of the body plate of the whipstock assembly of FIG. 2.

FIG. 3 is a schematic side view of the whipstock assembly of FIG. 2.

FIG. 3A is a cross-sectional view of the whipstock assembly of FIG. 3.

FIG. 4 is a schematic side view of an exemplary mold for forming the whipstock assembly of FIG. 1. The mold is shown with a body plate and filler material.

FIG. 5 is a cross-sectional view of an exemplary whipstock assembly having a communication channel.

FIG. 6 illustrates an exemplary embodiment of a packer and anchor assembly.

### DETAILED DESCRIPTION

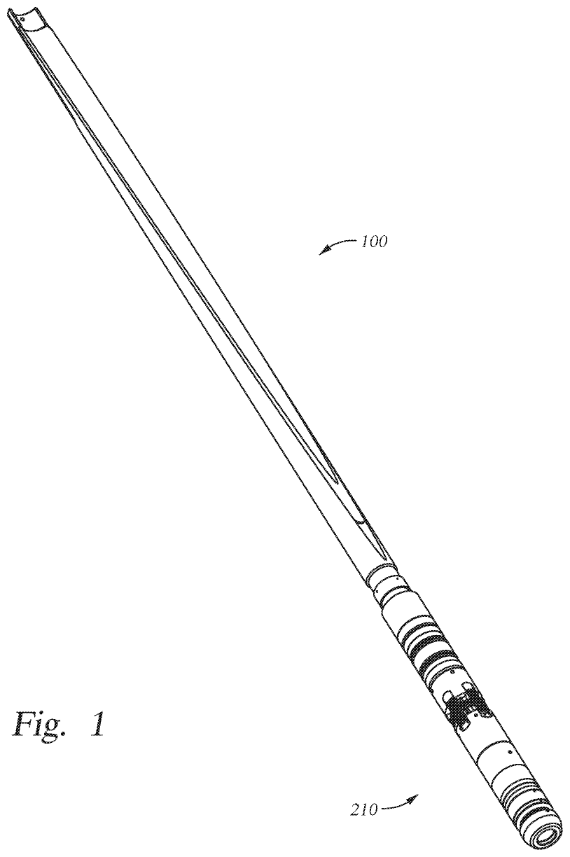

FIG. 1 is a perspective view of one embodiment of the whipstock assembly 100 for milling a window in a wellbore. The whipstock assembly 100 is shown attached to a packer and anchor assembly 210. The whipstock assembly 100 has a lower end for connecting to the packer and anchor assembly 210, and a concave shaped upper surface for guiding a drilling member such as a mill bit or a drill bit.

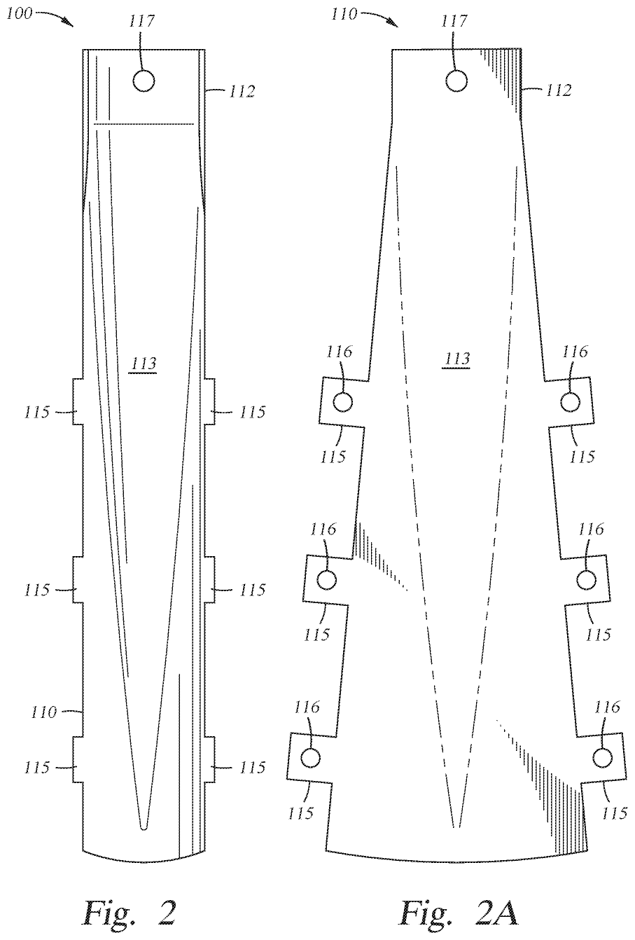

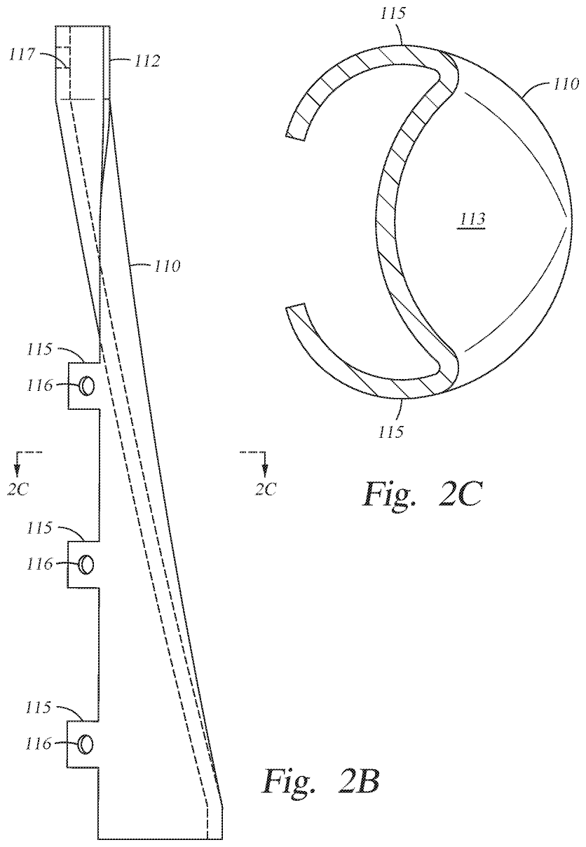

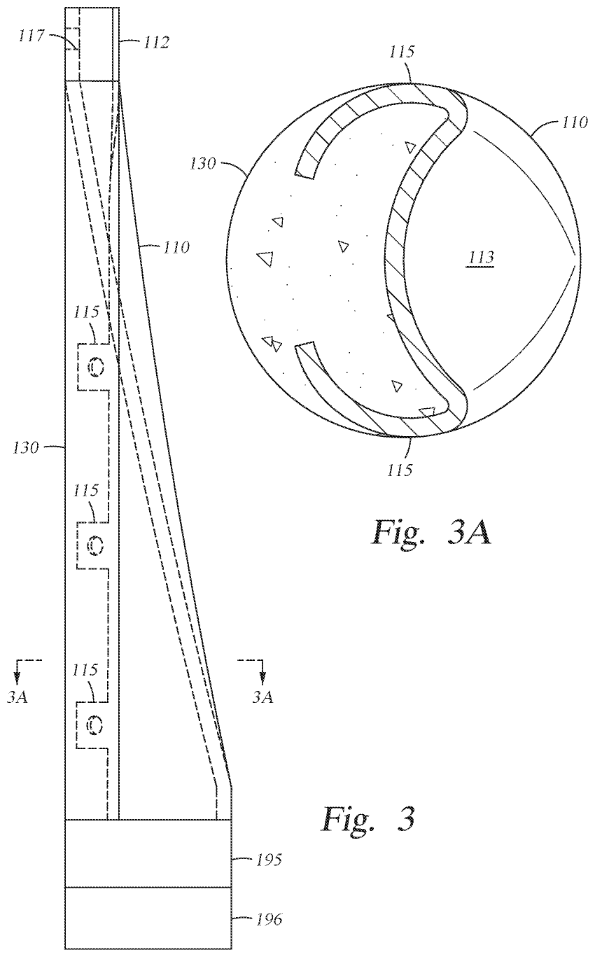

FIG. 2 is a schematic top view of one embodiment of the whipstock assembly 100 for milling a window in a wellbore. FIG. 3 is a schematic side view of the whipstock assembly 100. The whipstock assembly 100 includes a body plate 110 and a body core 130. In one embodiment, the body plate 110 is made from a flat metal plate.

FIG. 2A shows the body plate 110 after being cut from a flat metal plate. The body plate 110 is patterned on the plate and cut. The body plate 110 can be cut by using a stamping, laser cutting, water jet cutting, and other suitable cutting process. The body plate 110 may include a lug section 112 and a plurality of tabs 115. The tabs 115 may facilitate attachment of the body plate 110 to the body core 130. Locking features such as one or more holes 116 can be formed in each tab 115 enhance attachment to the body core 130. Other exemplary locking features include any suitable shape for enhancing attachment of the body plate 110 to the body core 130. For example, tabs 115 may have a rectangular shape, arcuate shape, a polygonal shape, or an irregular shape, such as a T-shape. The outline of the intended concave surface 113 of the body plate 110 is shown in dash lines. The lug section 112 includes a hole 117 for attachment to the mill. The lug section 112 may be integral to the body plate 110 or attached to the body plate 110, such as by welding. The body plate 110 may have a thickness range from 0.1 inches to 2 inches, from 0.2 inches to 1.1 inches, or from 0.4 inches to 0.8 inches. In one embodiment, the body plate 110 includes a hard facing such as a surface coating.

The flat plate cutout is formed into the desired shape of the body plate 110, as shown in FIG. 2. In one embodiment, the flat plate cutout is formed using a pressing operation to shape the body plate 110 and form the top concave surface 113 and the lug section 112 of the body plate 110. The tabs 115 are bent under to form an anchor feature. FIG. 2C shows a partial, cross-sectional view of the formed body plate 110. The concave surface 113 and two bent tabs 115 are shown in FIG. 2C. FIG. 2B is a partial, side view of the formed body plate 110, which includes the lug section 112 and one of the tabs 115. The hole 116 in the tabs 115 is not shown in FIGS. 2C and 2B. In another embodiment, the flat plate cutout may be formed using a hydroforming process, a rolling process, a multi-step forming operation, or a single-step forming operation. The formed body plate 110 may be used as the top surface skin of the whipstock 100.

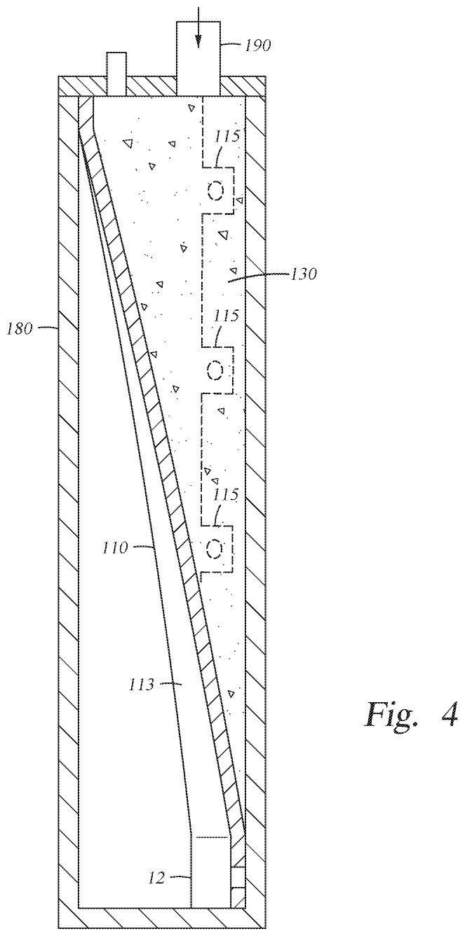

The formed body plate 110 is disposed in a mold 180 of the whipstock assembly 100. A filler material is added to the mold 180 and forms the body core 130 of the whipstock assembly 100. FIG. 4 is a schematic side view of the mold 180 after the filler material has been added. Exemplary filler materials include thermoset plastic, concrete, polyvinylidene fluoride polymers such as Kynar®, santoprene polymer, and other suitable filler materials. In one embodiment, the filler material is added using an injection port 190. The filler material is allowed to solidify before removal from the mold 180. In one embodiment, the body plate 110 acts as a partial or full outer shell of the whipstock assembly 100. For example, the body plate 110 may cover from 20% to 80% of the outer surface of the whipstock assembly 100. In one example, the body plate 110 is on the top surface in the mold 180. In another example, the body plate 110 is located interiorly in the mold 180, such that some filler material is disposed on top of the body plate 110.

FIGS. 3 and 3A shows the whipstock assembly 100 after being removed from the mold 180. FIG. 3 is a schematic side view of the whipstock assembly 100, and FIG. 3A is a cross-sectional view of the whipstock assembly 100. The body plate 110 is integrated with the body core 130, which is made of the filler material. The body plate 110 acts as the top guide surface for guiding a mill during a sidetrack drilling operation. The body core 130 provides the supporting structure for the body plate 110. FIG. 3A shows the tabs 115 locking the body plate 110 to the body core 130, thereby preventing the body plate 110 from separating from the body core 130.

In another embodiment, the whipstock assembly can be assembled after molding. For example, the body core can be made in a mold. After removal from the mold, the body core can be attached to the body plate. In one example, the body core is bonded to the body plate. The body plate acts as the top guide surface for guiding a mill during a sidetrack drilling operation. The body core provides the supporting structure for the body plate. The body plate can optionally include tabs to facilitate attachment to the body core.

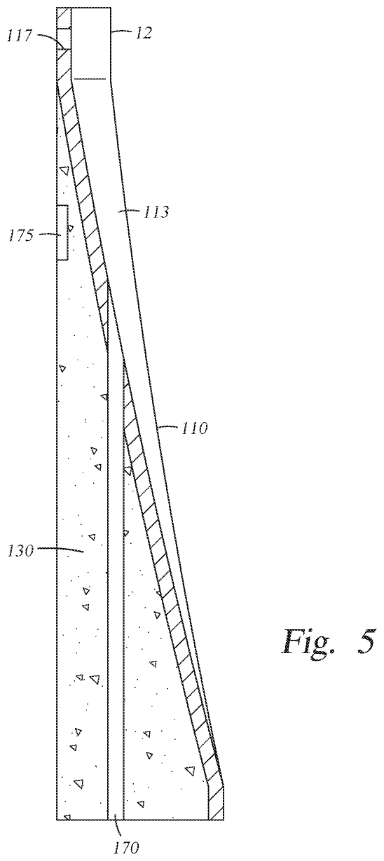

In one embodiment, a communication channel 170 may be formed in the whipstock assembly 100, as shown in FIG. 5. The channel 170 is formed in the body core 130 and communicates through an aperture formed in the body plate 110. The communication channel 170 may be used to communicate a fluid such as gas or liquid. The communication channel 170 may be used to house a communication line such as an electrical line, fiber line, a wire line, and other suitable communication lines. In one embodiment, the communication channel 170 is formed during the molding process. For example, the mold 180 includes a channel feature such that the communication channel 170 is formed when the filler material is added around the channel feature in the mold 180. In another embodiment, the communication channel 170 is formed after the whipstock assembly 100 is removed from the mold 180, such as by drilling. In another embodiment, the communication channel 170 is formed as a recess in the outer surface of the whipstock assembly 100.

In another embodiment, a “hollow” whipstock is formed using the molding process. For example, the mold 180 includes a bore such that core body 130 includes a core bore. The core bore may be co-axial with the whipstock assembly 100 centerline. In one example, the core bore is larger than a communication channel 170. In another example, the whipstock assembly includes a core bore and one or more communication channels. In another embodiment, a retrieval slot 175 for receiving a retrieval tool to retrieve the whipstock assembly 100 is molded into the whipstock assembly 100.

In one embodiment, an adapter 195 is added to the whipstock assembly 100 to facilitate connection to a downhole tool 196 such as a packer and anchor assembly, as shown in FIG. 3. The adapter 195 may be formed with the whipstock assembly 100 during the molding process. In another example, the adapter 195 is attached to the whipstock assembly 100 after the whipstock assembly 100 is removed from the mold 180. In another embodiment, the downhole tool 196 is attached to the adapter 195 or is integral with the adapter 195.

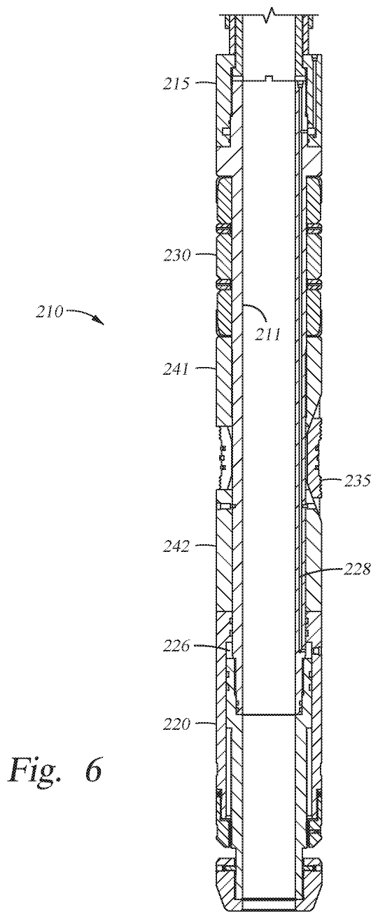

FIG. 6 illustrates an exemplary embodiment of a packer and anchor assembly 210. The assembly 210 includes a mandrel 211, a locking sleeve 215, an actuating sleeve 220, a sealing element 230, a plurality of slips 235, and wedge members 241, 242. The locking sleeve 215 is configured to lock the adapter 195 to the packer and anchor assembly 210. In one embodiment, the locking sleeve 215 has inwardly facing shoulders for engaging the shoulders of the adapter 195. The locking sleeve 215 may be threadedly connected to the mandrel 211.

The actuating sleeve 220, the sealing element 230, the plurality of slips 235, and the wedge members 241, 242 are disposed on the outer surface of the mandrel 211. The sealing member 230 is positioned between a shoulder of the mandrel 211 and an upper wedge member 241. The slips 235 are disposed between the upper wedge member 241 and the lower wedge member 242. The actuating sleeve 220 is disposed below the lower wedge member 242. An annular chamber 226 is defined between the actuating sleeve 220 and the mandrel 211. One or more seal rings may be used to seal the annular chamber 226. A hydraulic channel 228 through the mandrel 211 may be used to supply hydraulic fluid to the chamber 226. It is contemplated embodiments of the whipstock assembly 100 may be used with any suitable packer, anchor, or a combination of packer and anchor assembly. For example, the anchor may include a plurality of slips disposed on a mandrel having a bore. The packer may include a sealing element disposed on a mandrel having a bore.

In operation, the whipstock assembly 100 is assembled with the packer and anchor assembly 210. A mill is attached to the upper end of the whipstock assembly 100 such as via the hole 117 of the lug section 112. For example, the mill can be releasably attached to the lug section 112 using a shearable lug or screw. The whipstock assembly 100 is lowered into the wellbore using a workstring. After reaching the location of the window to be formed, the packer and anchor assembly 210 is set below the window. Hydraulic fluid is supplied to the chamber 226 to urge the actuating sleeve 220 upward, thereby moving the lower wedge member 242 closer to the upper wedge member 241. As a result, the slips 235 are urged up the inclined of the wedge members and outwardly into engagement with the surround casing. After setting the slips 235, weight is set down on the whipstock assembly 100, thereby compressing the sealing element 230 between the shoulder of the mandrel 211 and the upper wedge member 241. The sealing element 230 is urged outwardly into engagement with the surrounding casing to seal off fluid communication through the annulus.

Additional pressure is applied to the mill to release the mill from the whipstock assembly 100. For example, sufficient pressure is applied from the surface to break the shearable lug or screw connecting the mill to the lug section 112 of the whipstock assembly 100. The mill is then urged along the concave surface 113 of the whipstock assembly 100, which deflects the mill outward into engagement with the casing.

After the window is formed, the mill is retrieved. A retrieval tool is lowered into the wellbore to connect with the retrieval slot 175 formed in the body core 130. A pull force is then applied to the retrieval tool to release the sealing element 230 and the slips 235. After retrieving the whipstock assembly 100, fluid communication is re-established in the wellbore. In another embodiment, the whipstock assembly 100 and packer and anchor assembly 210 are removed using a drilling operation.

In one embodiment, a method of manufacturing a whipstock assembly includes cutting a shape of a body plate from a flat metal plate; forming a concave surface in the body plate; and attaching a body core to the body plate in a mold.

In another embodiment, a method of manufacturing a whipstock assembly includes cutting a shape of a body plate from a flat metal plate; forming a concave surface in the body plate; forming a body core in a mold; removing the body core from the mold; and attaching the body plate to the body core.

In one or more of the embodiments described herein, the shape of the body plate includes at least one tab.

In one or more of the embodiments described herein, the method includes bending the at least one tab.

In one or more of the embodiments described herein, attaching the body core includes attaching the body core to an inner surface of the body plate; and at least partially disposing the at least one tab in the core body.

In one or more of the embodiments described herein, the at least one tab includes a locking feature.

In one or more of the embodiments described herein, the locking feature comprises a hole formed in the tab.

In one or more of the embodiments described herein, a pressing operation to form the concave surface.

In one or more of the embodiments described herein, the shape of the body plate is cut using a stamping process, a laser cutting process, or a water jet cutting process,

In one or more of the embodiments described herein, the shape of the body plate includes a lug section.

In one or more of the embodiments described herein, the body core is attached to the body plate by adding a filler material to the mold and allowing the filler material to solidify in the mold.

In one or more of the embodiments described herein, a filler material is injected into the mold.

In one or more of the embodiments described herein, the filler material is selected from the group consisting of thermoset plastic, concrete, polyvinylidene fluoride polymers, and santoprene polymer.

In one or more of the embodiments described herein, the method includes forming a retrieval slot in the body core.

In one or more of the embodiments described herein, the method includes forming a communication channel in the body core.

In another embodiment, a whipstock assembly includes a body plate having a concave surface and a plurality of tabs; and a body core attached to the body plate, wherein the body core is formed in a mold with the body plate.

In one or more of the embodiments described herein, the plurality of tabs are at least partially disposed in the body core.

In one or more of the embodiments described herein, a communication channel formed in the body core.

In one or more of the embodiments described herein, the body plate includes a hole for fluid communication with the communication channel.

In one or more of the embodiments described herein, the body plate has a thickness from 0.1 inches to 2 inches.

In one or more of the embodiments described herein, the body core comprises a filler material selected from the group consisting of thermoset plastic, concrete, polyvinylidene fluoride polymers, and santoprene polymer.

In one or more of the embodiments described herein, the whipstock assembly includes an adapter for connection to a downhole tool.

In one or more of the embodiments described herein, the adapter is formed in the mold.

While the foregoing is directed to embodiments of the present disclosure, other and further embodiments of the disclosure may be devised without departing from the basic scope thereof, and the scope thereof is determined by the claims that follow.

1. A method of manufacturing a whipstock assembly, comprising:
cutting a shape of a body plate from a flat metal plate;
forming a concave surface in the body plate; and
attaching a body core to the body plate in a mold.

2. The method of claim 1, wherein the shape of the body plate includes at least one tab.

3. The method of claim 2, further comprising bending the at least one tab.

4. The method of claim 3, wherein attaching the body core comprises:
attaching the body core to an inner surface of the body plate; and
at least partially disposing the at least one tab in the core body.

5. The method of claim 2, wherein the at least one tab includes a locking feature.
The method of claim 5, wherein the anchoring feature comprises a hole formed in the tab.

6. The method of claim 1, wherein forming a concave surface in the body plate comprises using a pressing operation to form the concave surface.

7. The method of claim 6, wherein cutting the shape of the body plate is performed using a stamping process, a laser cutting process, or a water jet cutting process,

8. The method of claim 1, wherein the shape of the body plate includes a lug section.

9. The method of claim 1, wherein attaching the body core to the body plate comprises adding a filler material to the mold and allowing the filler material to solidify in the mold.

10. The method of claim 9, wherein adding the filler material comprises injecting a filler material into the mold.

11. The method of claim 9, wherein the filler material is selected from the group consisting of thermoset plastic, concrete, polyvinylidene fluoride polymers, and santoprene polymer.

12. The method of claim 1, further comprising forming a retrieval slot in the body core.

13. The method of claim 1, further comprising forming a communication channel in the body core.

14. A whipstock assembly, comprising:
a body plate having a concave surface and a plurality of tabs; and
a body core attached to the body plate, wherein the body core is formed in a mold with the body plate.

15. The whipstock assembly of claim 14, wherein the plurality of tabs are at least partially disposed in the body core.

16. The whipstock assembly of claim 14, further comprising a communication channel formed in the body core.

17. The whipstock assembly of claim 16, wherein the body plate includes a hole for fluid communication with the communication channel.

18. The whipstock assembly of claim 14, wherein the body plate has a thickness from 0.1 inches to 2 inches.

19. The whipstock assembly of claim 14, wherein the body core comprises a filler material selected from the group consisting of thermoset plastic, concrete, polyvinylidene fluoride polymers, and santoprene polymer.

20. The whipstock assembly of claim 14, further comprising an adapter for connection to a downhole tool.

21. The whipstock assembly of claim 20, wherein the adapter is formed in the mold.

22. A method of manufacturing a whipstock assembly, comprising:
cutting a shape of a body plate from a flat metal plate;
forming a concave surface in the body plate;
forming a body core in a mold;
removing the body core from the mold; and
attaching the body plate to the body core.
